(19) United States
(12) Patent Application Publication
(10) Pub. No.: US 2003/0112783 A1
(43) Pub. Date: Jun. 19, 2003

(54) Method of propagating a message and corresponding communications devices for the same

(75) Inventor: Paul J. Rankin, Horley (GB)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/315,812

(22) Filed: Dec. 10, 2002

(30) Foreign Application Priority Data
Dec. 14, 2001 (GB) 0129888.4

(51) Int. Cl. H04Q 7/24

(52) U.S. Cl. 370/338; 370/352

(57) ABSTRACT

A method of propagating a message is disclosed together with corresponding communications devices for the same. The method comprises the steps of (i) transmitting the message from a first communications device (IB) to a second communications device (MT1); (ii) transmitting the message, part of the message or a related message to a third communications device (MT2, MT3, MT4, DU) which is identified by an address contained in the second communications device (MT1); and (iii) providing a computer automated reward to an entity associated with the second communications device (MT1) in relation to the message transmitted to the third communications device in step (ii), wherein, at least prior to step (i), the address identifying the third communications device (MT2, MT3, MT4, DU) is unknown to the first communications device (IB).

### FIELD OF INVENTION

This invention relates to a method of propagating a message and corresponding communications devices for the same.

### BACKGROUND TO INVENTION

It is known to provide information beacons for broadcasting messages containing advertising and promotional electronic vouchers or coupons to nearby receivers, often incorporated in mobile cellular telephones or PDAs. Such beacons are typically located in shopping malls wherein the advertising and e-vouchers relate to services and products available in the vicinity. Also, such beacons would typically use a short range RF communications link such as Bluetooth (a registered trademark of Telefonaktiebolaget L M Ericsson, Sweden), IEEE802.11 or Zigbee, an infra red link such as irDA.

It is further known to use large scale text messaging to mobile cellular telephones, e.g. using SMS, and e-mailing to computers as a means for mail shot advertising.

In so far as promoting a commercial activity is concerned, it is of course desirable for the area of effective coverage and the number of potential recipients of such messages to be maximized for any given communications infrastructure. However, whilst using an information beacon is advantageous in that messages containing information specific to the location of the beacon, it is not possible to reach receivers outside the range of the beacon and so attract the attention of users of those devices. Electronic mail shot advertising is neither location specific nor cheap (especially in relation to text messaging) and additionally requires the address of the recipient to be known before hand.

### OBJECT OF INVENTION

It is therefore an object of the invention to provide an improved method of message propagation.

### SUMMARY OF INVENTION

According to the present invention, such a method is provided comprising the steps of (i) transmitting the message from a first communications device to a second communications device; (ii) transmitting the message, part of the message or a related message to a third communications device which is identified by an address contained in the second communications device; and (iii) providing a computer automated reward to an entity associated with the second communications device in relation to the message transmitted to the third communications device in step (ii), wherein, at least prior to step (i), the address identifying the third communications device is unknown to the first communications device.

Such a method enables a message to be propagated to communications devices which would otherwise not receive the message. This includes where there is no direct communication link between the first and third communications devices, where the third communications device is out of range of the first and where, at least prior to step (i), the third communications device is unknown to the first communications device.

Also, where the entity associated with the third communications device is a contact or personal friend of that of the second device, the information contained in the message is more likely to be receive greater attention by that contact or personal friend. This is quite obviously desirable where the message contains advertising.

The provision of a reward acts as an encouragement for to the entity associated with the second communications device to pass on the message and may comprise a voucher to be redeemed for goods or services, or a discount thereon and in the case of an e-voucher, it may be transmitted to the second communications device. The reward may also be money credited to an account belonging to the entity associated with the second communications device or, where the second communications device is a mobile cellular telephone, the reward may be provided via the corresponding cellular telephone network provider, e.g. in the form of air time.

Concerning message routing, the message may be transmitted to the third communications device directly from the second communications device (upon which the automated reward may be provided). Alternatively, the message may be transmitted to the third communications device indirectly by transmitting the address identifying the third communications device from the second communications device (also upon which the automated reward may be provided).

In the case of indirect routing, the message may be transmitted to the third communications device from a communications device, other than the second communications device, which has received the address. For example, the address may be transmitted from the second communications device to the first communications device and the message transmitted to the third communications device from the first communications device. Alternatively, a fourth communications device may be used whereby the address is transmitted from the second communications device to the fourth communications device, optionally via the first communications device, and the message transmitted to the third communications device from the fourth communications device.

Concerning the nature of the communications devices in the aforementioned method, the first communications device may be an information beacon configured to wirelessly broadcast the message to receivers located nearby, in range of the beacon, wherein the second communications device contains a short range communications receiver for receiving the broadcast of the beacon.

The second communications device may be a mobile cellular telephone having an address book containing the address of the third communications device and, optionally, containing a communications receiver, other than one used for communication with a cellular telephone network, for receiving messages broadcast wirelessly from a nearby transmitter.

The third mobile communications device may be a computer identified by an email address or a mobile cellular telephone identified by a telephone number.

Also provided in accordance with the present invention are corresponding system and device claims as recited in claim 20 to claim 27 of the accompanying claims.

### BRIEF DESCRIPTION OF DRAWING

The present invention will now be described, by way of example only, with reference to the accompanying schematic figure in which:

FIG. 1 depicts a communications infrastructure with which a message may be propagated using methods according to the present invention.

### DETAILED DESCRIPTION

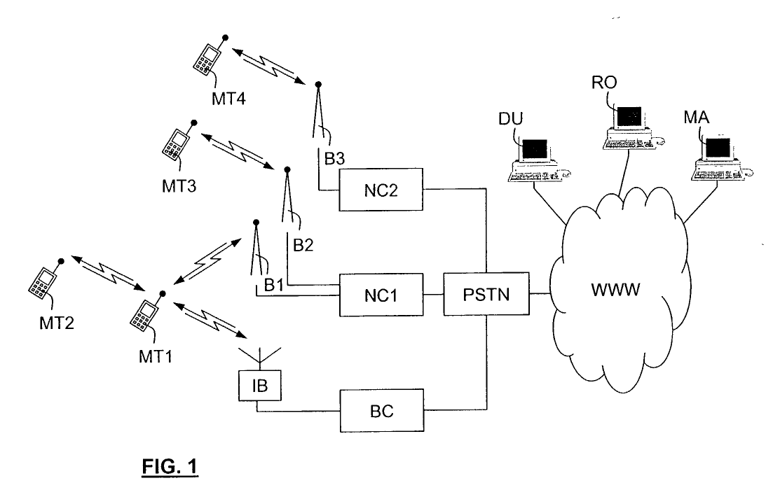

In the communications infrastructure depicted in FIG. 1, information beacon IB broadcasts information using a Bluetooth short range communications link to nearby Bluetooth transceivers. This information relates to the beacon's locality and includes a directory of local businesses, advertising in relation to products and services of those local businesses and e-vouchers in relation to those products and services. In particular, information is broadcasted about a local retail outlet RO. All information is tagged by meta data for personal filtering and supplemented by links to related information including URL's and telephone numbers.

Mobile cellphone telephone MT1 is registered with nearby cellular telephone network base station B1 facilitating voice and data communication (including text messaging and Internet access) via that base station with corresponding cellular telephone network controller NC1 and public switched telephone network PSTN. Telephone MT1 may also communicate directly with nearby Bluetooth transmitters and receivers including the information beacon IB and telephone MT2.

Mobile cellphone telephone MT2 is able to communicate directly with nearby Bluetooth receivers including telephone MT1 although for the purposes of illustration, it is assumed that telephone MT2 is out of range of the information beacon IB.

Mobile cellphone telephone MT3 is registered with nearby cellular telephone network base station B2 facilitating voice and data communication via that base station with corresponding cellular telephone network controller NC1, i.e. utilizing the same telephone network as telephone MT1.

Mobile cellphone telephone MT4 is registered with nearby cellular telephone network base station B3 facilitating voice and data communication via that base station with corresponding cellular telephone network controller NC2, i.e. utilizing a different network operator as telephones MT1 and MT3.

Three on-line computer systems are depicted belonging to a domestic user DU, a retail outlet RO which is located in the vicinity of the information beacon and a media agency MA respectively, each connected to the world-wide web (www).

As the aforementioned components of the communications infrastructure shown in FIG. 1 are entirely conventional, aspects of those components which do not directly relate to the present invention will not be elaborated upon here further.

Using its Bluetooth communications link, information beacon IB broadcasts messages to receivers in its vicinity including mobile telephone MT1. In accordance with the present invention and as illustrated in each of the following examples, that information may be further propagated to receivers with no direct communication link to the information beacon including mobile telephones MT1, MT2, MT3 & MT4 and fixed domestic user terminal DU and the user of mobile telephone MT1 is correspondingly rewarded.

### EXAMPLE 1

A retail outlet uses its computer system RO to instruct an on-line media agency's computer system MA to advertise a forthcoming sale at the retail outlet using information beacons located in the vicinity of the retail outlet. The media agency's computer system MA instructs beacon controller BC to configure information beacon IB to broadcast messages advertising the forthcoming sale and these messages are received by mobile telephone MT1 using its Bluetooth link.

The message broadcast by the information beacon IB further includes a offer to the user of mobile telephone MT1 that if can provide addresses of other users, e.g. friends or family, who may be interested in the sale at the retail outlet, the user will be rewarded with free air time from the mobile telephone network provider (not shown) for mobile telephone MT1. The network provider is the operator of network controller NC1.

The mobile telephone MT1 is configured to send, under the instruction of the user, contact details of several friends stored by the telephone which includes the telephone numbers of mobile telephones MT2, MT3 and MT4, and the email address for the PC of a domestic user DU. These contact details are sent via the beacon, PSTN, and web to the computer system of the media agency (MA). Upon receiving these contact details, the computer system of the media agency sends text messages via the PSTN and respective cellular telephone networks to telephones MT2, MT3 and MT4, and an email to the email address for the PC of a domestic user DU. Each of these contains advertising for the forthcoming sale at the retail outlet. The computer system of the media agency also sends an instruction to the network controller NC1 to request the network provider for mobile telephone MT1 reward the user with additional air time.

### EXAMPLE 2

As example 1 except that each of the text messages sent by the media agency to telephones MT2, MT3 and MT4, and the email sent to domestic user DU contains a hyperlink which directs a user to the website of the retail outlet. The hyperlink also contains an identifier associated with the user of mobile telephone MT1. If a user of any of telephones MT2, MT3 or MT4, or the domestic user select this hyperlink and view the retail outlets website, say hosted on computer system RO, the “hit” is reported to the computer system of the media agency MA. For each hit, the computer system of the media agency sends an instruction to the network controller NC1 to request the network provider for mobile telephone MT1 reward the user with additional air time. Optionally, if a “hit” results in an on-line purchase from the retail outlet, the user may be rewarded with more air time.

### EXAMPLE 3

As example 1 in so far as the retail outlet uses its computer system RO to instruct an on-line media agency's computer system MA to advertise a forthcoming sale at the retail outlet using information beacons located in the vicinity of the retail outlet.

However, an alternative offer is included in the message broadcast from the information beacon IB suggesting that the user directly forward the message to his or her contacts. This is perhaps preferable to example 1 and 2 in that the user's contacts are not disclosed to a third party.

As with example 2, the message contains a hyperlink which directs a user to the website of the retail outlet and also contains an identifier associated with the user of mobile telephone MT1. If the user of telephone MT1 forwards the email to his contacts (the users of telephones MT2, MT3 and MT4, and domestic user DU) and one of those contacts select the hyperlink and views the retail outlets website, the “hit” is reported to the computer system of the media agency MA. For each group of 5 hits originating from messages forwarded by mobile telephone MT1, the computer system of the media agency sends an instruction to the network controller NC1 to request the network provider for mobile telephone MT1 reward the user with additional air time. For each subsequent group of 5 hits, the amount of air time provided as a reward diminishes.

### EXAMPLE 4

As example 1 in so far as the retail outlet uses its computer system RO to instruct an on-line media agency's computer system MA to advertise a forthcoming sale at the retail outlet using information beacons located in the vicinity of the retail outlet.

However, an e-coupon is included in the message broadcast from the information beacon IB with the suggestion that the user of mobile telephone MT1 directly forward the message including the e-coupon (with identifier associating it with the user of mobile telephone MT1) to his or her contacts. If one those contacts redeemed the e-coupon at the retail outlet, the custom is reported to the computer system of the media agency MA and the user is rewarded with air-time as previously discussed.

### EXAMPLE 5

As examples 1 to 4 except that the media agency rewards the user of mobile telephone MT1 by transmitting e-coupons to telephone MT1 which can be redeemed at the retail outlet RO.

With examples 3 and 4, the user is responsible for forwarding the message to his or her contacts. In each example, the message may be sent wholly or in part, and may be repacked in that the user's electronic stationary or template styles may be applied to the message. Furthermore, this forwarding may be done immediately whilst within the beacon's range or postponed, by storing the message in the telephone MT1, for delayed forwarding. This may be either from the mobile handset, for example, at a time when the tariff for such messaging is lower, or from a fixed network point (not shown) such as a home or office telephone to which the mobile telephone MT1 has docked and uploaded the message.

The costs for such forwarding operations may be borne by the media operating agency and/or the retail outlet by providing a toll free or reduced toll number via which messages can be sent. For example, a message may be forwarded by sending it to a toll free number of the media agency with the telephone number of the user's contact in the payload. The contact number could be stripped from the text message by the computer system of the media agency and the message retransmitted to the contact at the cost of the media agency.

Also, whilst the invention is primarily described in the context of mobile telephones, it will of course be appreciated that other communications devices including PDAs, laptop computers and desktop computers might equally be used in place of such mobile telephones.

From reading the present disclosure, other modifications will be apparent to persons skilled in the art. Such modifications may involve other features which are already known in the design and use of data communications systems and component parts thereof and which may be used instead of or in addition to features already described herein. Although claims have been formulated in this application to particular combinations of features, it should be understood that the scope of the disclosure of the present application also includes any novel feature or any novel combination of features disclosed herein either explicitly or implicitly or any generalization of one or more of those features which would be obvious to persons skilled in the art, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A method of propagating a message comprising the steps of:
(i) transmitting the message from a first communications device to a second communications device;
(ii) transmitting the message, part of the message or a related message to a third communications device which is identified by an address contained in the second communications device; and
(iii) providing a computer automated reward to an entity associated with the second communications device in relation to the message transmitted to the third communications device in step (ii),
wherein, at least prior to step (i), the address identifying the third communications device is unknown to the first communications device.

2. A method according to claim 1 wherein, in step (ii), the message transmitted to the third communications device is transmitted from the second communications device.

3. A method according to claim 2 wherein the automated reward is provided upon transmitting the message to the third communications device from the second communications device.

4. A method according to claim 1 further comprising the step of transmitting the address identifying the third communications device from the second communications device wherein, in step (ii), the message transmitted to the third communications device is transmitted from a communications device, other than the second communications device, which has received the address identifying the third communications device from the second communications device.

5. A method according to claim 2 wherein the automated reward is provided upon transmitting the address identifying the third communications device from the second communications device.

6. A method according to claim 4 wherein the address identifying the third communications device is transmitted from the second communications device to the first communications device; and wherein the message transmitted to the third communications device is transmitted from the first communications device.

7. A method according to claim 4 wherein the address identifying the third communications device is transmitter from the second communications device to a fourth communications device via the first communications device; and wherein the message transmitted to the third communications device is transmitted from the fourth communications device.

8. A method according to claim 1 wherein the first communications device is an information beacon configured to wirelessly broadcast the message to receivers located nearby, in range of the beacon; and wherein the second communications device contains a short range communications receiver for receiving the broadcast of the beacon.

9. A method according to claim 1 wherein the second communications device is a mobile cellular telephone having an address book containing the address of the third communications device.

10. A method according to claim 9 wherein the second communications device contains a communications receiver, other than one used for communication with a cellular telephone network, for receiving messages broadcast wirelessly from a nearby transmitter.

11. A method according to claim 9 or claim 10 wherein the third mobile communications device is a computer which is identified by an email address.

12. A method according to claim 9 or claim 10 wherein the third mobile communications device is a mobile cellular telephone which is identified by a telephone number.

13. A method according to claim 1 wherein the message comprises advertising.

14. A method according to claim 1 wherein the messages comprises an e-voucher to be redeemed for goods or services, or a discount thereon.

15. A method according to claim 1 wherein the reward comprises a voucher to be redeemed for goods or services, or a discount thereon.

16. A method according to claim 15 wherein the voucher is an e-voucher and is transmitted to the second communications device.

17. A method according to claim 15 wherein the reward comprises money which is credited to an account belonging to the entity associated with the second communications device.

18. A method according to claim 15 wherein the second communications device is a mobile cellular telephone and the reward via the corresponding cellular telephone network provider.

19. A method according to claim 18 wherein the reward is in the form of air time.

20. A communications system comprising:
first and second communications devices wherein the first communications device is configured to transmit a message to the second communications device whereby, at least prior to transmission of that message, the second communication contains an address identifying a third communications device unbeknown to the first communications device; and
a computer reward system configured to provide a computer automated reward to an entity associated with the second communications device upon either the message or part of the message being forwarded to the third communications device from the second communications device.

21. A communications system comprising:
first and second communications devices wherein the first communications device is configured to transmit a message to the second communications device whereby, at least prior to transmission of that message, the second communication contains an address identifying a third communications device unbeknown to the first communications device; and
a computer reward system configured to provide a computer automated reward to an entity associated with the second communications device upon transmitting the address identifying the third communications device from the second communications device.

22. A communications system according to claim 21 wherein the second communications device is configured to transmit the address identifying the third communications device to the first communications device; and wherein the first communications device is configured to transmit the message originally transmitted to the second communications device, part of that message or a related message to the third communications device.

23. A communications system according to claim 21 further comprising a fourth communications device, wherein the second communications device is configured to transmit the address identifying the third communications device to a fourth device via the first communications device; and wherein the fourth communications device is configured to transmit the message originally transmitted to the second communications device, part of that message or a related message to the third communications device.

24. An information beacon configured to wirelessly broadcast to a communications device located nearby, in range of the beacon, a message containing an invitation directed to the entity associated with the communications device to forward the message or part thereof to another communications device and receive a computer automated reward for doing so.

25. An information beacon configured to wirelessly broadcast to a communications device located nearby, in range of the beacon, a message containing an invitation directed to the entity associated with the communications device to transmitting an address identifying another communications device and receive a computer automated reward for doing so.

26. A communications device configured to receive a message and automatically recognize in that message an invitation directed to the entity associated with the communications device to forward the message or part thereof to another communications device and receive a computer automated reward for doing so.

27. A communications device configured to receive a message and automatically recognize in that message an invitation directed to the entity associated with the communications device to transmit an address identifying another communications device and receive a computer automated reward for doing so.
